(19) United States
(12) Patent Application Publication
(10) Pub. No.: US 2008/0267431 A1
(43) Pub. Date: Oct. 30, 2008

(54) Mems Microphone

(75) Inventors: Anton Leidl, Hohenbrunn (DE); Wolfgang Pahl, Munich (DE); Ulrich Wolff, Kaiserslautern (DE)

Correspondence Address: FISH & RICHARDSON PC, P.O. BOX 1022, MINNEAPOLIS, MN, 55440-1022, US

(73) Assignee: EPCOS AG, Munich (DE)

(21) Appl. No.: 11/816,969

(22) PCT Filed: Feb. 8, 2006
(86) PCT No.: PCT/EP06/01121

§ 371 Date: May 22, 2008

(30) Foreign Application Priority Data
Feb. 24, 2005 (DE) 10 2005 008 511.3

(51) Int. Cl. H04R 1/00

(52) U.S. Cl. 381/173; 381/369

(57) ABSTRACT

A microphone includes a first diaphragm and a second diaphragm coupled to the first diaphragm by a closed air volume. The first diaphragm and the second diaphragm each constitutes a piezoelectric diaphragm. The first diaphragm and the second diaphragm are electrically coupled so that movement of the first diaphragm causes movement of the second diaphragm.

### TECHNICAL FIELD

This patent application describes a MEMS microphone (MEMS=Micro Electromechanical System).

### BACKGROUND

U.S. Pat. No. 4,816,125 describes a MEMS microphone with a piezoelectric layer made from ZnO and several electrodes connected to this layer that are arranged concentrically.

The following publication describes a microphone module with an encapsulated MEMS microphone, in which an enclosed air volume (back volume) is in a housing underneath the microphone's diaphragm: J. J. Neumann, Jr. and K. J. Gabriel, “A fully integrated CMOS-MEMS audio microphone,” the 12th International Conference on Solid State Sensors, Actuators, and Microsystems, 2003 IEEE, pp. 230-233.

The following publication describes an electrical module with an installed MEMS piezoresistive microphone: D. P. Arnold, et al., “A directional acoustic array using silicon micromachined piezoresistive microphones,” J. Acoust. Soc. Am., Vol. 113(1), 2003, pp. 289-298.

The following publication describes a piezoelectric microphone, which has two piezoelectric layers made from ZnO and a floating electrode arranged in-between: Mang-Nian Niu and Eun Sok Kim, “Piezoelectric Bimorph Microphone Built on Micromachined Parylene Diaphragm,” Journal of Microelectromechanical Systems, Vol. 12, 2003 IEEE, pp. 892-898.

### SUMMARY

Described herein is a sensitive microphone with a high signal-to-noise ratio.

It has been found that microphones that detect sound pressure using diaphragms are usually dependent on a large diaphragm displacement as a reaction to sound intensity in order to achieve desired characteristics in terms of sensitivity and noise behavior. For small components with built-in microphones, achievable displacement is limited by small diaphragm area. When diaphragm displacement is converted into an electrical quantity, only weak electrical signals can be obtained. The elasticity of a diaphragm produced in a deposition process can be negatively affected by a bias caused by a high internal mechanical stress.

MEMS microphones described here have an air chamber connected to a sound inlet opening and also a back volume. An enclosed air volume that prevents an acoustic short circuit—an undesired pressure balance between the front and back sides of the oscillating diaphragm—is referred to as a back volume. This air volume generates a restoring force for each diaphragm displacement in addition to the restoring force caused by the elastic diaphragm characteristics. For small components, the back volume is so small that even small diaphragm displacements lead to a considerable increase in pressure in the back volume, which can be on the order of magnitude of the sound level to be detected. The additional restoring force decreases the elasticity and the displacement of the diaphragm.

A microphone is described with a first and a second diaphragm, which are each connected to one and the same closed air volume and are thus coupled to each other so that, for a displacement of the first diaphragm, a simultaneous displacement of the second diaphragm is generated.

The first diaphragm is a microphone diaphragm, i.e., a “passive” diaphragm, which detects the sound pressure or converts an acoustic signal into an electrical signal. The second diaphragm is an auxiliary diaphragm or an “active” diaphragm, whose displacement generated by electrical driving interacts with the “passive” diaphragm via the closed air volume.

Two different strategies are described for the electrically driving the active diaphragm:

1) “Holding the enclosed air volume constant”: For this purpose, a signal derived from the passive diaphragm and amplified is fed to the active diaphragm such that the active diaphragm performs an opposite but equal-magnitude motion that is similar or identical to that of the passive diaphragm. For example, if the passive diaphragm is driven to a certain volume displacement towards the interior of the cavity by the external sound pressure, then an electrical driving of the active diaphragm by the approximately equivalent volume displacement away from the interior of the cavity is realized. As a result, the fluctuation of the chamber volume is reduced or eliminated. In this way, it is possible to reduce pressure fluctuations caused by the sound pressure in the closed air volume considerably, e.g., by at least a factor of two, in one embodiment by at least a factor of five. This reduction in internal pressure fluctuations, however, also means a corresponding reduction in the diaphragm restoring force. The effective back volume thus appears significantly enlarged, in the limiting case as infinite.

2) “Compensation of the passive diaphragm displacement”: Here, the electrical driving of the active diaphragm is part of a control circuit that reduces or even eliminates the displacement of the passive diaphragm, despite the effect of the external acoustic field on the passive diaphragm. A measure for this displacement is the electrical output signal of the passive diaphragm, which is held close to zero by the control circuit. At each moment, the active diaphragm establishes, for this purpose, an internal pressure in the chamber, which is close or equal to the external pressure (sound pressure). The resulting differential pressure for the passive diaphragm is reduced or disappears completely, which also applies to its displacement. Without significant diaphragm displacement of the passive diaphragm, however, the back volume causes, in turn, no relevant restoring forces on this diaphragm. The output signal of the arrangement in this case is not that of the passive diaphragm (which is definitely driven to zero in the described way), but instead the drive signal of the active diaphragm formed in the control circuit.

In both cases, a virtual back volume is achieved that is greater than the real back volume by a multiple (in one construction by at least two times, in one embodiment construction by at least five times).

The two circuit-related strategies for reducing the effective restoring force run the risk of building up feedback oscillations in the entire system. In one embodiment, therefore, circuit-related measures are provided for recognizing and preventing such conditions.

In a first construction, a microphone is specified with a body in which two openings are provided, which open into a cavity formed in the body. A first diaphragm is arranged over a first opening and a second diaphragm (auxiliary diaphragm) is arranged over a second opening, so that an air volume is enclosed in the cavity. The second diaphragm may be decoupled acoustically from the exterior by another cavity. A space in which the source of an acoustic input signal is located is referred to as the exterior.

A chamber that is connected to the exterior and isolated from the cavity is arranged over the first diaphragm. The cavity is designated below as the back volume.

The first diaphragm is arranged in a first cavity wall over an opening formed in this wall. In one embodiment, the second diaphragm is arranged in a second cavity wall. The diaphragms may be arranged in opposite cavity walls. Because the acoustic pressure change is transmitted equally in all directions when the diaphragm is dispersed, it is also possible to arrange the two diaphragms in walls standing at right angles to each other. The two diaphragms can be arranged in the same cavity wall.

The two diaphragms may have essentially the same mass and can be formed identically. The (passive) first diaphragm acts as a microphone diaphragm, while the (driven) second diaphragm functions as a loudspeaker diaphragm. In the case of a piezoelectric MEMS microphone based on the direct piezoelectric effect, for example, the displacement of the first diaphragm is converted into an electrical signal. In a capacitive MEMS microphone, the relative position of the electrodes of the microphone changes. The associated change in capacitance is converted into an electrical signal. The respective diaphragm can be basically an electromechanical converter operating with an electric field or magnetic field.

The displacement of the second diaphragm can be generated like in a loudspeaker, e.g., by a changing electric or magnetic field. The displacement of the second diaphragm with piezoelectric properties can be generated on the basis of the inverse piezoelectric effect.

In an embodiment, both diaphragms each have at least one piezoelectric layer. Both diaphragms may be constructed identically. Alternatively, it is possible for the electromechanical conversion in the diaphragms to be based on different electromechanical effects. For example, the first diaphragm can function as a capacitive MEMS microphone and the second diaphragm can function as a piezoelectric converter.

In one embodiment, a vent opening can be provided, which connects the enclosed air volumes (back volume of the microphone) and the exterior and which is small relative to the cross-sectional size of the diaphragm and which is used for slow pressure balancing, e.g., in the range of ≧100 ms. The pressure balancing is performed slowly relative to the period of an acoustic signal with the largest wavelength in the operating range of the microphone. This opening can be arranged in the diaphragm or in a wall of the container that encloses the acoustic back volume.

By virtue of the described compensation measures according to the first and the second embodiment, it is possible to reduce the real acoustic back volume (i.e., the closed air volume) relative to known microphones without an auxiliary diaphragm, so that space savings can be achieved. Nevertheless, because the virtual back volume can be kept sufficiently large, no disadvantageous consequences (loss of sensitivity) occur due to the smaller construction.

To prevent an acoustic short circuit of a driven auxiliary diaphragm to the exterior or to the sound inlet opening, an additional cavity isolated from the exterior is provided in an advantageous variant as an acoustic back volume for the auxiliary diaphragm. The additional cavity is separated by the auxiliary diaphragm from the closed air volume. The additional cavity can be smaller than the closed air volume, because the auxiliary diaphragm is driven actively and thus its displacement is set. The space requirements of the microphone arrangement can accordingly be kept small overall.

A microphone will be explained in detail below on the basis of embodiments and the associated figures. The figures show different embodiments of the microphone on the basis of schematic representations that are not to scale. Parts that are identical or that have identical functions are labeled with the same reference symbols.

### DESCRIPTION OF THE DRAWINGS

FIG. 1A, a part of a microphone according to a first embodiment, comprising two electrically coupled diaphragms in a schematic cross section;

FIG. 1B, equivalent circuit diagram of the microphone according to FIG. 1A;

FIGS. 2, 3, each a variant of the embodiment shown in FIG. 1;

FIG. 4A, a part of a microphone according to the second variant;

FIG. 4B, equivalent circuit diagram of the microphone according to FIG. 4A;

FIG. 5, an example microphone diaphragm in a schematic cross section;

FIG. 6, a metal layer, in which two electrodes connected electrically to external contacts are formed.

### DETAILED DESCRIPTION

FIG. 1A shows a microphone with a body GH, which has openings AU1, AU2 opening into a cavity HR2 on its opposing walls HW1, HW2. A first diaphragm M1 (microphone diaphragm, passive diaphragm) is arranged over the first opening AU1 and a second diaphragm M2 (auxiliary diaphragm, driven diaphragm) is arranged over the second opening AU2.

The diaphragm M1, M2 can be mounted on the walls of the body GH. Alternatively, the diaphragm M1, M2 can be replaced by a microphone chip with a carrier substrate and a diaphragm mounted thereon. The microphone chip can be connected fixedly to the body GH, e.g., by an adhesive layer.

The first diaphragm M1 separates the cavity HR2 from a chamber HR1, which is connected to the exterior via a sound inlet opening IN. The first diaphragm M1 begins to vibrate as soon as an acoustic pressure p is exerted on it. The change in pressure in the chamber HR1 and the vibration of the diaphragm M1 would lead to a change in volume or pressure in the cavity HR2 (without the auxiliary diaphragm M2) and an associated restoring force, which acts on the first diaphragm M1 and reduces the vibration amplitude. Due to an electrical coupling of the two diaphragms M1, M2, they vibrate in such a manner that the displacement of the first diaphragm M1 is towards the interior of the cavity HR2 and the displacement of the second diaphragm M2 is realized with the same amplitude towards the outside. The active diaphragm M2 is driven in a push-pull way with respect to the passive first diaphragm M1. Here, a reduced change or no change at all in the volume of the cavity HR2 occurs.

The second diaphragm M2 separates the cavity HR2 from an additional closed cavity HR3, which is isolated from a space connected to a sound source, i.e., the exterior and the chamber HR1. The additional cavity HR3 prevents feedback of the active diaphragm onto the passive diaphragm on the outer path.

The additional cavity HR3 and/or the chamber HR1 can be created, e.g., by a cap-shaped, dimensionally stable cover.

In FIG. 1B, a simplified equivalent circuit diagram of diaphragms M1, M2 coupled by a control circuit V1 is shown. For a displacement of the passive diaphragm M1 caused by the sound pressure, an electrical signal is generated that can be tapped at the output OUT as a usable signal for further processing. A part of the electrical signal is used for generating a control signal at the output of the control circuit V1, with which the auxiliary diaphragm M2 is driven in a push-pull way (relative to the internal pressure established in the cavity HR2) with respect to the passive diaphragm.

The drive circuit V1 may contain an amplifier for amplifying the signal tapped at the diaphragm M1.

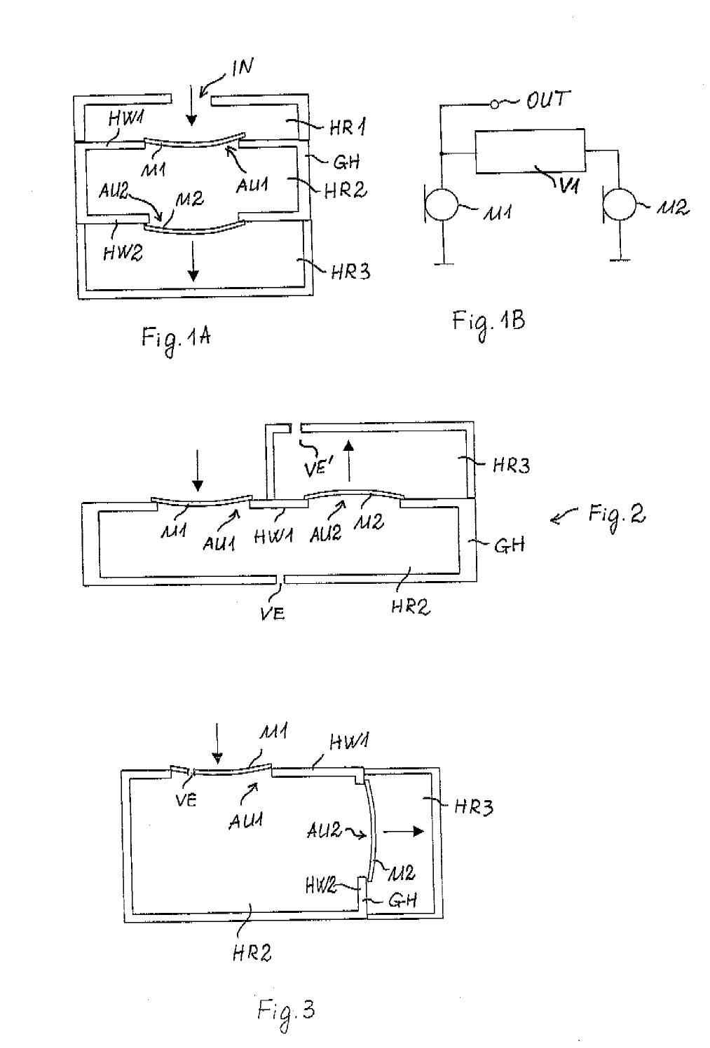

FIG. 2 shows an embodiment of the microphone presented in FIG. 1, in which both diaphragms M1, M2 are arranged in the same cavity wall HW1. In a cavity wall of the cavity HR2, a small ventilation opening VE connecting this cavity and the exterior is provided, whose cross-sectional size is clearly smaller (e.g., by at least a factor of 100) than the cross-sectional size of the diaphragm or the openings AU1 or AU2 and which is used for slow pressure balancing, e.g., in the range of ≧100 ms. In a cavity wall of the cavity HR3, a small ventilation opening VE′ connecting this cavity and the exterior is also provided.

In FIG. 3, the openings AU1, AU2 are provided in mutually perpendicular walls. The ventilation opening VE is formed here in the diaphragm M1.

The direction of the diaphragm displacement is indicated with arrows in FIGS. 1 to 4A, B.

In a variant of the embodiment presented in FIG. 4A, the active second diaphragm M2 is driven in a push-pull way (relative to the internal pressure) with the passive first diaphragm M1 in contrast to FIG. 1A. Here, the displacements of the two diaphragms are directed towards the interior of the air volume enclosed in the cavity HR2. In FIG. 4A, a dashed line shows how the passive diaphragm M1 would deform due to external sound pressure. A solid line shows the actual position of the diaphragm M1 achieved due to the compensating effect of the active diaphragm M2, wherein the diaphragm M1 remains practically in its rest position or oscillates with a very small amplitude relative to the displacement of the active diaphragm M2.

FIG. 4B shows an equivalent circuit diagram to the embodiment according to FIG. 4A. The electrical signal tapped at the diaphragm M1 is processed by the control circuit RK. On one hand, a control signal for driving the diaphragm M2 is output and, on the other, another control signal, which is superimposed on the signal tapped at the diaphragm M1 and damps the oscillation amplitude of the diaphragm M1. An output signal at the output OUT can be evaluated. The output OUT is connected here to the diaphragm M2.

In the variants presented in FIGS. 2 and 3, it is also possible to drive the active diaphragm M2 in common mode relative to the passive diaphragm M1, in order to damp the displacement amplitude of the passive diaphragm M1 in addition to the restoring force acting on this diaphragm.

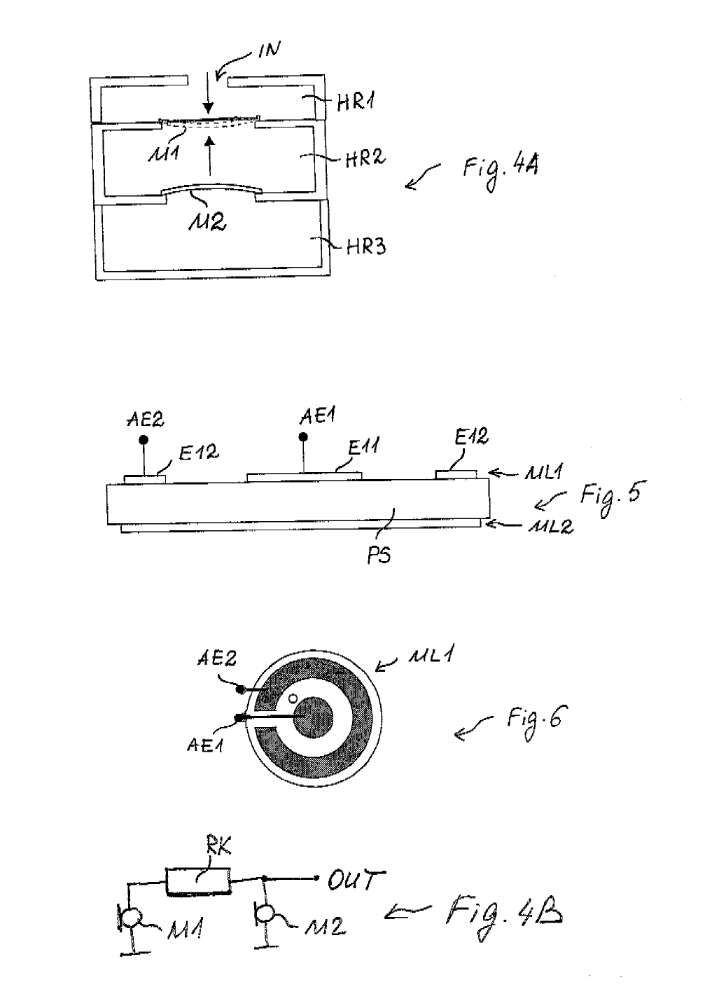

FIG. 4B shows the equivalent circuit diagram of a microphone, which comprises a control circuit RK for compensating the displacement of the diaphragm M1. The output signal OUT2 is obtained here from the control circuit, while the signal of the converter M1 is held close to zero by the effect of the control. An example of a diaphragm with a piezoelectric layer PS arranged between two metal layers ML1, ML2 is shown in FIGS. 5 and 6. Electrodes E11 and E12 connected to the external contacts AE1, AE2 are arranged in the first metal layer ML1. A floating conductive area, which lies opposite the two electrodes E11, E12, is formed in the second metal layer ML2. Here, two capacitors connected to each other in series are formed.

In FIG. 6, a first metal layer ML1 of the diaphragm presented in FIG. 5 is shown. The round electrode E11 is arranged in a first high-potential region and the annular electrode E12 is arranged in a second high-potential region. The two high-potential regions have opposite polarity. The electrodes E11, E12 are each connected to external contacts AE1 and AE2, respectively. In a metal layer ML2 arranged underneath or above and shown in FIG. 5, a continuous, floating, conductive surface may be arranged, which is opposite the two electrodes E11, E12.

The microphone is not limited to the number of elements shown in the figures or to the acoustically audible range from 20 Hz to 20 kHz. The microphone can also be used in other piezoelectric acoustic sensors, e.g., distance sensors operating with ultrasound. A microphone chip with a described microphone can be used in any signal-processing module. Different embodiments can also be combined with each other.

1-18. (canceled)

19. A microphone comprising:
a first diaphragm; and
a second diaphragm coupled to the first diaphragm by a closed air volume;
wherein the first diaphragm and the second diaphragm each comprises a piezoelectric diaphragm; and
wherein the first diaphragm and the second diaphragm are electrically coupled so that movement of the first diaphragm causes movement of the second diaphragm.

20. The microphone of claim 19, further comprising
structure that defines a first cavity, the structure having a first opening and a second opening that lead to the first cavity;
wherein the first diaphragm is over the first opening and the second diaphragm is over the second opening, thereby defining the closed air volume;
wherein the second diaphragm is electrically controlled so that, if the first diaphragm moves towards an interior of the first cavity, the second diaphragm moves away from the interior of the first cavity; and
wherein a volume displacement resulting from movement of the second diaphragm is between 50% and 100% of a volume displacement resulting from movement of the first diaphragm.

21. A microphone comprising:
a first diaphragm; and
a second diaphragm coupled to the first diaphragm by a closed air volume;
wherein the first diaphragm and the second diaphragm are electrically coupled so that movement of the first diaphragm causes movement of the second diaphragm; and
wherein movement of the first diaphragm and movement of the second diaphragm occur in a same direction relative to the closed air volume.

22. The microphone of claim 21, further comprising
structure that defines a first cavity, the structure having a first opening and a second opening that lead to the first cavity;
wherein the first diaphragm is over the first opening and the second diaphragm is over the second opening, thereby defining the closed air volume; and
wherein a volume displacement resulting from movement of the second diaphragm is between 50% and 100% of a volume displacement resulting from movement of the first diaphragm.

23. A microphone comprising:
a first diaphragm; and
a second diaphragm coupled to the first diaphragm by a closed air volume;
wherein the first diaphragm and the second diaphragm are electrically coupled so that movement of the first diaphragm causes movement of the second diaphragm; and
wherein the first diaphragm and the second diaphragm are not opposite each other relative to the closed air volume.

24. The microphone of claim 23, further comprising
structure that defines a first cavity, the structure having a first opening and a second opening that lead to the first cavity;
wherein the first diaphragm is over the first opening and the second diaphragm is over the second opening, thereby defining the closed air volume;
wherein the second diaphragm is electrically controlled so that, if the first diaphragm moves towards an interior of the first cavity, the second diaphragm moves away from the interior of the first cavity due; and
wherein a volume displacement resulting from movement of the second diaphragm is between 50% and 100% of a volume displacement resulting from movement of the first diaphragm.

25. A microphone comprising:
a first diaphragm; and
a second diaphragm coupled to the first diaphragm by a closed air volume;
wherein the first diaphragm and the second diaphragm are electrically coupled so that movement of the first diaphragm causes movement of the second diaphragm;
wherein the closed air volume functions as a back volume; and
wherein structure that defines the closed air volume includes a ventilation opening to balance an internal pressure of the closed air volume with an external pressure outside of the microphone, where pressure balancing occurs over a time that exceeds a period of an acoustic signal applied to the first diaphragm.

26. A microphone comprising:
a first diaphragm coupled to a closed air volume; and
a driver to output a control signal to control a device to counteract sound pressure exerted on the first diaphragm and thereby dampen an oscillation amplitude of the first diaphragm.

27. The microphone of claim 26, wherein changes in pressure on both sides of the first diaphragm are essentially equal in magnitude.

28. The microphone of claim 26, wherein the device comprises a second diaphragm, and the control signal is for controlling the second diaphragm so that displacement of the first diaphragm results in displacement of the second diaphragm so as to produce a change in pressure in the closed air volume that substantially counteracts the sound pressure and thereby reduces displacement of the first diaphragm by 50%-100%.

29. The microphone of claim 26, wherein the device comprises a second diaphragm coupled to the closed air volume; and
wherein the first diaphragm is connected to a first wall and the second diaphragm is connected to a second wall, the first and second walls being part of a structure that houses the closed air volume.

30. The microphone of claim 29, wherein the first and second walls face each other.

31. The microphone of claim 29, wherein the first and second walls are substantially perpendicular.

32. The microphone of 26, wherein the device comprises a second diaphragm coupled to the closed air volume; and
wherein the first and second diaphragms are arranged along a same wall that is part of a structure that houses the closed air volume.

33. The microphone of claim 26, wherein the device comprises a second diaphragm coupled to the closed air volume; and
wherein the first and second diaphragms have substantially same masses.

34. The microphone of claim 26, wherein the device comprises a second diaphragm coupled to the closed air volume; and
wherein the first and second diaphragms have substantially same shapes.

35. The microphone of claim 26, further comprising:
a chamber that includes a sound inlet opening that leads to an exterior of the microphone, the chamber being adjacent to the first diaphragm and isolated from the closed air volume.

36. The microphone of claim 26, wherein the device comprises a second diaphragm coupled to the closed air volume; and
wherein the driver comprises a control circuit that taps an electrical signal from the first diaphragm and that outputs the control signal to the second diaphragm to produce a displacement that affects internal pressure in the closed air volume and thereby reduces displacement of the first diaphragm.

37. The microphone of claim 36, wherein the control circuit comprises an amplifier.

38. The microphone of claim 26, wherein the device comprises a second diaphragm coupled to the closed air volume; and
wherein a structure housing the closed air volume comprises at least one ventilation opening to an exterior of the microphone, the ventilation opening being is smaller than cross-sectional areas of the first and second diaphragms.

39. The microphone of claim 38, wherein the ventilation opening is in the first diaphragm or in a wall of the structure.

40. The microphone of one of claims 26, wherein the device comprises a second diaphragm coupled to the closed air volume; and
wherein the closed air volume is a first closed air volume, and the second diaphragm is coupled to a second closed air volume on a side that is different from a side that faces the first closed air volume.

41. The microphone of claim 26, wherein the device comprises a second diaphragm coupled to the closed air volume; and
wherein the driver comprises an electrical circuit connected to the first diaphragm and/or to the second diaphragm to reduce feedback oscillations.
